(19) United States
(12) Patent Application Publication
(10) Pub. No.: US 2019/0171387 A1
(43) Pub. Date: Jun. 6, 2019

(54) DIRECT MEMORY ADDRESSES FOR ADDRESS SWAPPING BETWEEN INLINE MEMORY MODULES

(71) Applicants: Thomas WILLHALM, Sandhausen (DE); Francesc GUIM BERNAT, Barcelona (ES); Karthik KUMAR, Chandler, AZ (US); Benjamin GRANIELLO, Chandler, AZ (US); Mustafa HAJEER, Hillsboro, OR (US)

(72) Inventors: Thomas WILLHALM, Sandhausen (DE); Francesc GUIM BERNAT, Barcelona (ES); Karthik KUMAR, Chandler, AZ (US); Benjamin GRANIELLO, Chandler, AZ (US); Mustafa HAJEER, Hillsboro, OR (US)

(21) Appl. No.: 16/264,451

(22) Filed: Jan. 31, 2019

(51) Int. Cl. G06F 3/06; G06F 12/1027; G06F 13/28

(52) U.S. Cl. CPC G06F 3/0647; G06F 3/0604; G06F 3/0673; G06F 2212/683; G06F 13/28; G06F 2212/1044; G06F 12/1027

(57) ABSTRACT

Techniques and mechanisms for wear leveling across dual inline memory modules (DIMMs) by migrating data using direct memory accesses. In an embodiment, a direct memory access (DMA) controller detects that a metric of accesses to a first page of a first DIMM is outside of some range. Based on the detecting, the DMA controller disables an access to the first page by a processor core. While the access is disabled, the DMA controller performs DMA operations to migrate data from the first page to a second page of a second DIMM. The first page and the second page correspond, respectively, to a first physical address and a second physical address. In another embodiment, an update to address mapping information replaces a first correspondence of a virtual address to the first physical address with a second correspondence of the virtual address to the second physical address.

### BACKGROUND

### 1. Technical Field

Embodiments of the invention relate to computer memory and more particularly, but not exclusively, to wear leveling for multiple inline memory modules.

### 2. Background Art

In computer and electronic device operations, various types of non-volatile memory provide great advantages in the maintenance of data, providing low power operation and high density. Because data is stored in a compact format that requires minimal power in operation and does not require power to maintain storage, such memory is being used in increasing numbers of applications.

However, non-volatile memory has certain downsides in operation. For example, 3D XPoint memory (and other such memories) have a limited lifespan in use because such memory tends to deteriorate with each write cycle. For this reason, if a certain portion of the memory is subject to more write operations than other portions of the memory, then the portions with a greater number of writes will tend to deteriorate and ultimately fail more quickly.

Wear leveling has traditionally been implemented in order to lengthen the overall lifespan of non-volatile memory. A wear leveling process is applied to more evenly distribute the wear over a memory device by directing write operations to less heavily used portions of that memory device. Wear leveling typically uses an algorithm for re-mapping logical block addresses to different physical block addresses in a memory device.

### BRIEF DESCRIPTION OF THE DRAWINGS

The various embodiments of the present invention are illustrated by way of example, and not by way of limitation, in the figures of the accompanying drawings and in which:

FIG. 1 is a functional block diagram illustrating elements of a system to swap pages, with direct memory access circuitry, of dual inline memory modules according to an embodiment.

FIG. 2 is a flow diagram illustrating elements of a method for swapping pages of respective inline memory modules with a direct memory access according to an embodiment.

FIG. 3 is a functional block diagram illustrating elements of circuitry to facilitate an address swap with a direct memory access according to an embodiment.

FIG. 4 is a functional block diagram illustrating elements of a circuit to determine when an address swap is to be performed with a direct memory access according to an embodiment.

FIG. 5 is a functional block diagram illustrating elements of a system to perform an address swap, with direct memory access circuitry, between dual inline memory modules according to an embodiment.

FIG. 6 is a data map illustrating memory addressing which is updated to provide an address swap between inline memory modules according to an embodiment.

FIG. 7 is a functional block diagram illustrating a computing device in accordance with one embodiment.

FIG. 8 is a functional block diagram illustrating an exemplary computer system, in accordance with one embodiment.

### DETAILED DESCRIPTION

Embodiments discussed herein variously provide techniques and mechanisms for wear leveling across multiple dual inline memory modules (DIMMs), where the wear leveling is based on a migration of data using direct memory accesses. In an embodiment, a direct memory access (DMA) controller facilitates operations—referred to herein as address swapping operations—which replace a first correspondence, between a virtual address and a first physical address, with a second correspondence, between that same virtual address and a second physical address. The first physical address and the second physical address identify, respectively, a first memory segment (e.g., a page) of a first DIMM, and a second memory segment of a second DIMM.

Traditional wear leveling techniques (where applied in memory systems which include one or more DIMMs) have been on an intra-DIMM basis—e.g., entirely within a single DIMM—and/or have relied upon software to manage address swapping. Certain embodiment provide improvements to such techniques by mitigating the risk of one DIMM failing well before another DIMM.

In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

It is pointed out that those elements of the figures having the same reference numbers (or names) as the elements of any other figure can operate or function in any manner similar to that described, but are not limited to such.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including multiple DIMMs and circuitry to support DMA to said multiple DIMMs.

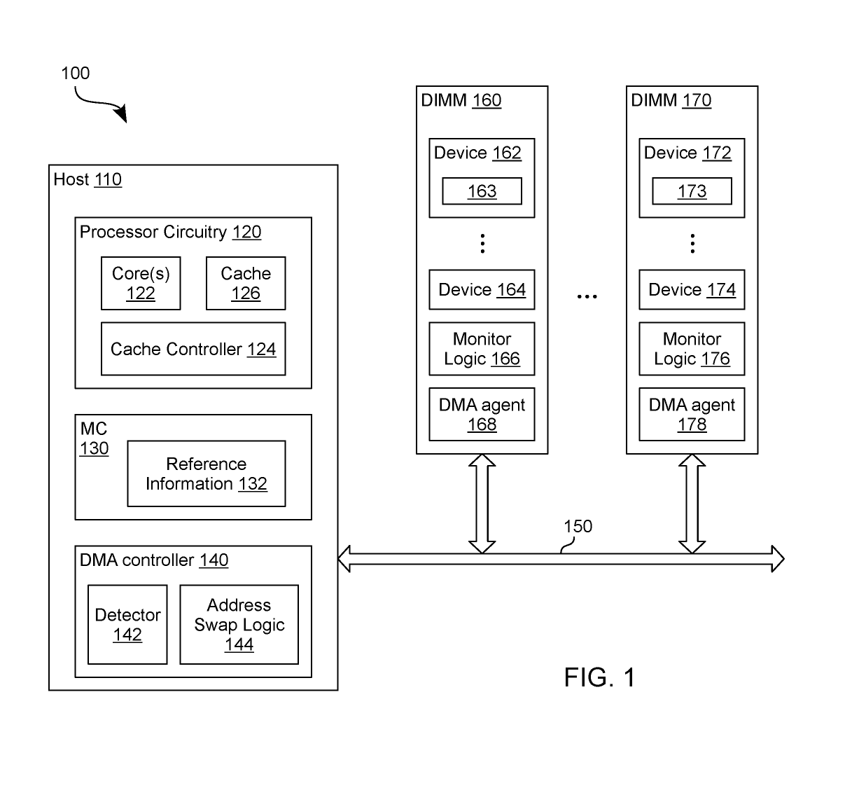

FIG. 1 shows features of a system 100, according to an embodiment, to provide direct memory access (DMA) functionality in support of address swapping for segments of different respective DIMMs. System 100 is one example of an embodiment wherein DMA circuitry is used to dynamically substitute the use of a memory segment of one DIMM for the use of a memory segment of another DIMM.

In an embodiment, system 100 is one of a desktop, server, workstation, laptop, handheld, television set-top, media center, game console, integrated system (such as in a car), or other type of computer system. In several embodiments, a host 110 of system 100 includes one or more processing units, also referred to as “processors.” Although in many embodiments there are potentially many processing units, in the embodiment shown in FIG. 1 only one processor (comprising processor circuitry 120) is shown for clarity. Processor circuitry 120 is that of of an Intel® Corporation CPU or a CPU of another brand, for example. Processor circuitry 120 includes one or more cores 122—e.g., wherein the processor comprises one core, four cores, eight cores, or the like. In many embodiments, each core of the one or more cores 122 includes respective internal functional blocks such as one or more execution units, retirement units, a set of general purpose and specific registers, etc.

In many embodiments, host 110 comprises a memory controller MC 130 which is coupled to (or alternatively, integrated with) the processor which includes processor circuitry 120. MC 130 provides an interface to communicate with a system memory which comprises a plurality of dual inline memory modules (DIMMs). In the example embodiment shown, the system memory includes DIMMs 160, . . . , 170 which are variously coupled to host 110 via one or more interconnects (e.g., including the illustrative interconnect 150 shown). Interconnect 150 includes one or more optical, metal, or other wires (i.e. lines) that are capable of transporting data, address, control, and clock information.

DIMMs 160, 170 each comprise respective random access memory (RAM) devices—e.g., including one or more 3D XPoint devices, one or more dynamic RAM (DRAM) devices, such as double data rate (DDR) DRAM, and/or the like. In the example embodiment shown, DIMM 160 comprises RAM devices 162, . . . , 164 which, for example, each include a respective packaged device coupled to a printed circuit board of DIMM 160. Similarly, DIMM 170 comprises RAM devices 172, . . . , 174 which include packaged devices variously coupled to a printed circuit board of DIMM 170. Some embodiments are not limited to a particular number of multiple DIMMs of system 100, to a particular number of packaged memory devices of any one such DIMM, or to a particular interconnect architecture by which such DIMMs are coupled to host 110.

The system memory is, for example, a general purpose memory to store data and instructions to be accessed (via MC 130) and operated upon by processor circuitry 120. Additionally, host 110 comprises circuitry—such as the illustrative direct memory access (DMA) controller 140 shown—which provides DMA-capable input and/or output (I/O) functionality to access the system memory independent of the access being requested by a software process which executes with the one or more cores 122. DMA controller 140 is to variously communicate with respective DMA agents of DIMMs 160, . . . , 170—e.g., wherein a DMA agent 168 of DIMM 160 and a DMA agent 178 of DIMM 170 are to variously communicate respective metric monitoring information to DMA controller 140.

System 100 supports address swapping for memory segments of different respective DIMMs—e.g., for a page 163 of device 162 and a page 173 of device 172—where address swapping is performed with DMA functionality such as that provided with DMA controller 140. In an example embodiment, operation of system 100 includes the one or more cores 122 variously accessing some or all of DIMMs 160, . . . , 170 via MC 130 and interconnect 150. Such accesses are based on information (such as the illustrative reference information 132 shown) which associates virtual addresses each with a respective physical address of a corresponding memory segment. Reference information 132—which is included in, or otherwise accessible to, MC 130—facilitates an address translation functionality with which data is accessed at a given memory location. In some embodiments, reference information 132 includes a page table, a translation lookaside buffer and/or any of various other data structures adapted, for example, from conventional memory access techniques. In one such embodiment, pages 163, 173 correspond to a first physical address and a second physical address (respectively), where—at some point during operation of system 100—reference information 132 defines or otherwise indicates a correspondence of the first physical address with a particular virtual address.

During such operation of system 100 (e.g., while page 163 is associated with the virtual address), circuit logic of system 100 monitors one or more metrics of accesses to at least one such DIMM. For example, in some embodiments, a given DIMM of system 100 includes multiple RAM devices and monitor logic (other than any RAM device of the DIMM) which is coupled to snoop or otherwise detect signals that are variously communicated between the RAM devices and MC 130. Based on such signals, the monitor logic calculates metrics, some or all of which (for example) are each based on accesses to a different respective one of the RAM devices. In the embodiment shown, DIMM 160 comprises RAM devices 162, . . . , 164 and monitor logic 166 which calculates one or more metrics each based on respective accesses to RAM device 162, one or more other metrics based on respective accesses to RAM device 164, etc. Alternatively or in addition, DIMM 170 comprises RAM devices 172, . . . , 174 and monitor logic 176 which calculates one or more metrics each based on respective accesses to RAM device 172, one or more other metrics based on respective accesses to RAM device 174, etc.

Functionality such as that of monitor logic 166 (or monitor logic 176) is, in other embodiments, distributed among multiple RAM devices of a given DIMM—e.g., where circuitry local to device 162 calculates a metric of accesses to device 162, circuitry local to device 164 calculates a metric of accesses to device 164, circuitry local to device 172 calculates a metric of accesses to device 172, and/or circuitry local to device 174 calculates a metric of accesses to device 174. In still other embodiments, functionality such as that of monitor logic 166 (or monitor logic 176) is instead implemented at host 110—e.g., where DMA controller 140, or circuitry coupled thereto, is further configured to detect signals communicated by MC 130 on interconnect 150, and to calculate metric values based on such signals.

In an embodiment, an access metric such as one calculated by monitor logic 166 (or by monitor logic 176) indicates an extent to which one or more lines of memory are being subject to wear due to overutilization. For example, such an access metric includes or is otherwise based on a number of accesses to a given line or page—e.g., wherein the accesses include only writes, only reads, or both writes and reads. By way of illustration and not limitation, an access metric includes or is otherwise based on a total number of accesses to-date, a number of accesses within a most recent period of time since a particular event, an average rate of accesses over a given period of time, or the like. In some embodiments, a metric is based on accesses to any of multiple memory lines—e.g., to any lines of a given page. Alternatively or in addition, one or more metrics are each specific to respective one (and only one) memory line of a given page—e.g., wherein multiple line-specific metrics are calculated each for a different respective line of the same one page.

In some embodiments, metric monitoring additionally or alternatively comprises determining whether some calculated value of a metric is outside of a predetermined range—e.g., wherein the range is defined at least in part by one or more threshold values. For example, monitor logic 166 performs regular evaluations, in various embodiments, each to compare a current value of a given metric with a corresponding threshold (or thresholds). A line of memory is subject to being migrated to another page where, for example, an evaluation indicates that a corresponding access metric is outside of some range of values.

In one illustrative embodiment, an access metric includes or is otherwise based on a count Cx of writes to a particular memory line x of a given page—e.g., where count Cx is reset every N cycles of a system clock (N being some predefined positive integer). For example, in response to the detection of a write to memory line x, count Cx is reset to some baseline or other default value—e.g., to one (1)—if more than N clock cycles have tolled since count Cx was last reset. Otherwise, detection of the write results in count Cx being incremented if it was last reset within the most recent N clock cycles. In such an embodiment, data of line x is subject to being identified as qualifying for migration to another physical page, where (for example) such identification is based at least in part on the count Cx being more than some predefined write count threshold Wth.

In some embodiments, circuitry of a DIMM provides functionality to evaluate whether a given metric value is outside of a corresponding acceptable range. For example, such functionality is provided with circuitry other than that of any RAM device (e.g., with monitor logic 166 or monitor logic 176). In other embodiments, such functionality is distributed among RAM devices of a DIMM—e.g., wherein some or all of devices 162, 164, 172, 174 each perform respective metric evaluations locally. In still other embodiments, such functionality is instead implemented at host 110—e.g., where DMA controller 140, or circuitry coupled thereto, is configured to receive metric values previously calculated (for example) with monitor logic 166 and monitor logic 176, and to evaluate said metric values at host 110. A calculation performed to determine a given metric value and/or to evaluate such a metric value—e.g., based on one or more threshold values—includes operations that (for example) are adapted from conventional memory wear leveling techniques. Some embodiments are not limited with respect to a particular technique for such access metric calculation and/or evaluation.

DMA controller 140 comprises a detector 142 which is coupled to detect, based on a previously-calculated metric of memory accesses, whether address swapping is to be performed—e.g., wherein, in lieu of a currently-associated first memory segment of a first DIMM, a virtual address is instead to be associated with a second memory segment of a second DIMM. In an example scenario according to one embodiment, detector 142 generates, receives or otherwise detects a result of a metric evaluation, where the result indicates excessive utilization of one or more memory lines at page 163. In response to such detection, address swap logic 144 of DMA circuit 140 determines that data at page 163 is to be migrated from DIMM 160 to an alternative page of some other DIMM.

For example, in some embodiments, during operation of system 100, some or all pages of a given DIMM are ranked in relative order to one another according to respective levels of utilization (e.g., as variously indicated each by a corresponding memory access metric). Such page ranking is updated regularly, for example, and is used to identify a currently-preferred (e.g., least utilized) candidate page of that DIMM—e.g., wherein monitor logic 166, monitor logic 176 and/or other such circuity variously provides the ranking of pages in DIMMs 160, . . . , 170.

In one such embodiment, respective candidate pages of DIMMs 160, . . . , 170 are variously identified to address swap logic 144—e.g., prior to (or alternatively, in response to) detector 142 detecting the metric evaluation result. The candidate pages are identified, for example, along with respective access metric information which enable address swap logic 144 to determine a most preferred page from among the identified candidate pages. Based on the identification of a preferred page (e.g., page 173) as an alternative to page 163, address swap logic 144 provides signaling to initiate, control, and/or otherwise determine operations that associate a virtual address with page 173, and that perform direct memory accesses to move data from page 163 to page 173.

For example, such signaling updates reference information 132 to replace a first correspondence, between the virtual address and the first physical address for page 163, with a second correspondence between the virtual address and the second physical address for page 173. Additionally or alternatively, such signaling suspends at least some functionality of the one or more cores 122—at least during data migration—that would otherwise facilitate memory access to one or both of pages 163, 173. For example, in an embodiment, processor circuitry 120 comprises one or more caches (such as the illustrative cache 126 shown) which are each coupled to—or alternatively, integrated with—a respective core of the one or more cores 122. In various embodiments, multiple caches are implemented so that multiple levels of cache exist between the execution units in each core and memory. In an embodiment, address swap logic 144 signals a cache controller 124 of processor circuitry 120 to invalidate information (such as one or more entries in a translation lookaside buffer) which would otherwise be available for use to access page 163. While a functionality of the one or more cores 122 to access page 163 is disabled, address swap logic 144 performs various direct memory access reads and writes—e.g., with MC 130—to migrate data from page 163 to page 173. After such data migration is completed, address swap logic 144 provides signaling to enable access one or both of pages 163, 173 by the one or more cores 122.

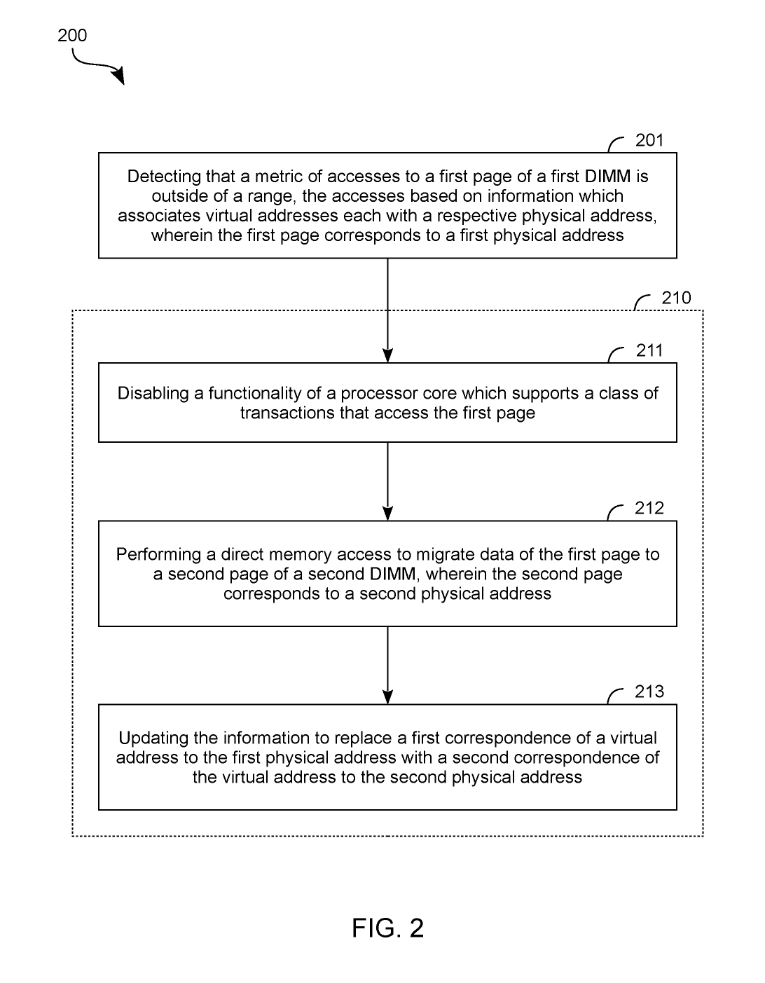

FIG. 2 shows features of a method 200 to perform an address swap for two DIMMs using a direct memory access according to an embodiment. Some or all of method 200 is performed, for example, with a controller circuit (such as DMA controller 140) which provides direct memory access functionality.

As shown in FIG. 2, method 200 includes (at 201) detecting that a metric of accesses to a first page of a first DIMM is outside of a range that, for example, is predetermined prior to such accesses. The accesses to the first page are based on information which associates virtual addresses each with a respective physical address—e.g., wherein the information is that of a page table or other address mapping resource which is included in, or otherwise accessible to, MC 130 (or other such memory controller circuitry). In such an embodiment, the first page corresponds to a first physical address which, during the detecting at 201, is associated by the information to some virtual address.

In some embodiments, the detecting at 201 includes or is otherwise based on circuitry of the first DIMM (such as circuitry of monitor logic 166) calculating a value of the metric, and performing an evaluation based on the value and a corresponding threshold value. The evaluation is to detect at least in part whether, according to some predetermined criteria, one or more memory lines of the first page are being over-utilized. A result of the evaluation is subsequently communicated from the first DIMM to the controller circuit, wherein the result indicates that the metric of accesses to the first page is outside of the range. Of all memory lines of the first page, the metric of accesses (in some embodiments) is based on accesses to only one memory line of the first page.

The first DIMM comprises multiple RAM devices (e.g., packaged RAM devices providing functionality of devices 162, . . . , 164). In one such embodiment, the detecting at 201 includes, or is otherwise based on, each of the multiple RAM devices performing respective operations to determine whether some page of that RAM device is being over utilized. For a given one of such RAM devices, these operations include (for example) calculating a respective metric of accesses to the RAM device, evaluating the respective metric based on a threshold value which corresponds to that RAM device, and communicating a result of the evaluation from the RAM device to the controller circuit.

Method 200 further comprises operations 210 which are performed, based on the detecting at 201, with the DMA-capable controller circuit. Operations 210 comprise (at 211) disabling a functionality of a processor core which supports a class of transactions that access the first page.

In one embodiment, the processor core comprises a translation lookaside buffer, wherein the disabling at 211 comprises the controller circuit invalidating an entry of the translation lookaside buffer (TLB)—e.g., by signaling a cache controller of the processor to invalidate any entries of the TLB which include an address or other reference to the first page. The disabling is performed, for example, independent of any explicit command from an operating system (or other software process) to invalidate such one or more TLB entries. For example, the controller circuit includes or otherwise has access to circuit logic (e.g., including one or more system level hardware hooks) to identify to a cache controller a page in memory for which transactions (if any) are to be blocked, delayed or otherwise prohibited.

Operations 210 further comprise (at 212) performing a direct memory access to migrate data of the first page to a second page of a second DIMM, wherein the second page corresponds to a second physical address. The direct memory access includes multiple DMA reads from the first page and multiple DMA writes to the second page—e.g., where such reads and writes are variously performed while the functionality of the processor core remains disabled.

In various embodiments, the direct memory access performed at 212 includes, or is otherwise based on, the controller circuit selecting the second page from among multiple pages, each of a respective DIMM other than the first DIMM, which have been variously identified to the controller circuit as being candidate pages to participate in address swapping. For each such page of the multiple pages, a utilization of the page is determined to be less than a utilization of a respective one or more other pages. In one such embodiment, the direct memory access performed at 212 further includes, or is otherwise based on, the controller circuit determining a ranked order of such multiple candidate pages relative to each other. The ranked order is based, for example, on access metrics which each correspond to a respective one of the multiple pages, wherein the second page is selected from among the multiple pages according to the ranked order.

In one example embodiment, the direct memory access performed at 212 includes, or is otherwise based on, circuitry of the second DIMM performing operations to identify a page which, as compared to some or all other pages of the second DIMM, is relatively less utilized, and thus a better candidate to participate in address swap operations. For example, such operations include determining access metrics which each correspond to a different respective page of the second DIMM, and determining, based on the access metrics, a ranked order of the multiple pages relative to each other. The second page is subsequently selected from among the multiple pages based on the ranked order, where the second DIMM then identifies the second page to the control circuit as a preferred candidate page.

Operations 210 further comprise (at 213) updating the information which is a basis for the accesses to the first page (information associating virtual addresses each with a respective physical address). Such updating (which, for example, is performed while the functionality of the processor core is disabled), replaces a first correspondence of a virtual address to the first physical address with a second correspondence of the virtual address to the second physical address. The updating includes operations adapted, for example, from conventional address mapping (e.g., remapping) techniques.

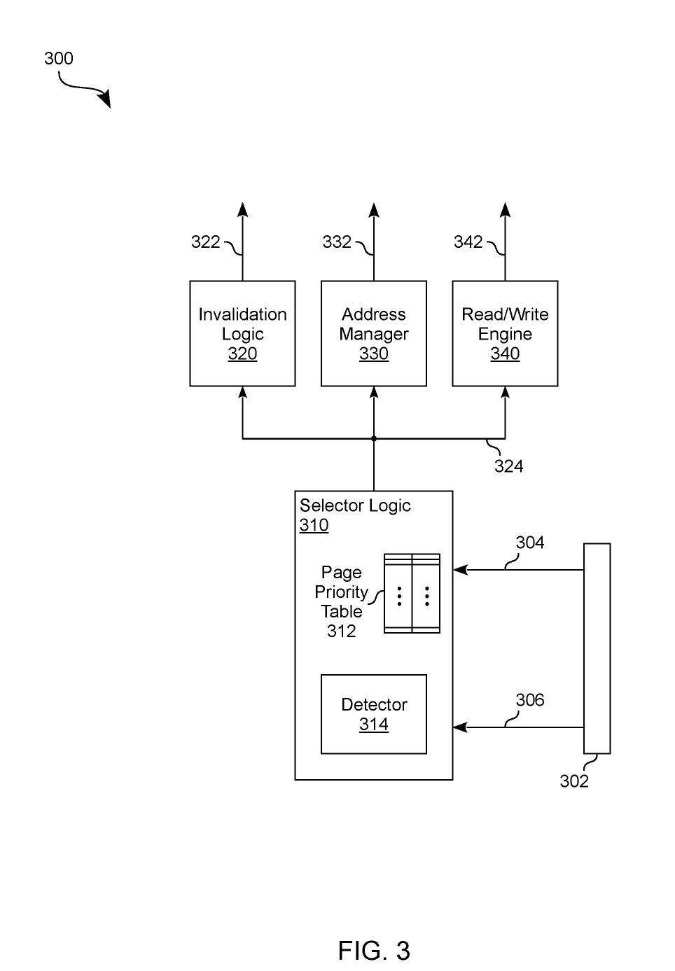

FIG. 3 shows features of a DMA controller circuit 300 to facilitate an address swap between DIMMs according to an embodiment. DMA controller circuit 300 includes features of DMA controller 140, for example, and/or is used to perform some or all of method 200.

As shown in FIG. 3, DMA controller circuit 300 includes interface circuitry 302 comprising one or more input and/or output (IO) interfaces by which DMA controller circuit 300 is to be coupled to multiple DIMMs and, in some embodiments, a processor core and/or a memory controller. A given IO interface of interface circuitry 302 comprises one or more conductive contacts each to communicate a respective data signal, address signal, control signal, monitored state signal or the like. In an embodiment, interface circuitry 302 is to be coupled to receive metric monitoring information from multiple DIMMs (e.g., including DIMMs 160, . . . , 170). In an embodiment, such monitoring information is based on an evaluation of a memory access metric—e.g., wherein the evaluation compares the memory access metric to a predefined threshold of utilization for one or more lines of memory. In some embodiments, monitoring information includes a memory access metric—e.g., where DMA controller circuit 300 is to locally perform the evaluation of the metric based on a predefined threshold value.

DMA controller circuit 300 further comprises selector logic 310 which is coupled to communicate with the multiple DIMMs via interface circuitry 302. Selector logic 310 provides functionality to identify a target page of one DIMM, where the target page is selected for receiving data that is to be migrated from another page, at a different DIMM, which has been determined to be over-utilized (according to some predefined criteria).

In an example, embodiment, selector logic 310 receives one or more signals 304 which indicate one or more pages each as being a respective candidate to participate in address swapping operations. Such candidate pages are each indicated, for example, by a respective DIMM of a system memory—e.g., where, for a given DIMM, a page of that DIMM is identified to DMA controller circuit 300 as being a preferred page at least with respect to one or more other pages of that DIMM. In some embodiments, a given DIMM identifies to DMA controller circuit 300 multiple candidate pages each of a different respective RAM device of that DIMM.

Based on the one or more signals 304, selector 310 generates or otherwise determines reference information (represented by the illustrative page priority table 312) which indicates a relative priority of candidate pages. In one embodiment, entries of page priority table 312 each include a respective page tag, physical address, or other such identifier of a corresponding page, and a rank value which is based on a corresponding metric access value. Page priority table 312 is updated over time by selector 310—e.g., responsive to the one or more signals 304 indicating when a different page of a given DIMM is a preferred candidate to participate in address swapping.

At some point in time during operation of DMA controller circuit 300, a detector 314 included in (or alternatively coupled to) selector logic 310 receives, via interface circuitry 302, another signal 306 which identifies a particular page of the multiple DIMMs as being over-utilized (and thus at risk of excessive wear). Responsive to signal 306 indicating such an over-utilized page, selector logic 310 selects, from among currently-identified candidate pages, a target page to participate in address swapping—e.g., where the selection is according to a prioritization of the candidate pages which are indicated by page priority table 312.

Based on the selection of a target page, selector logic 310 communicates one or more signals (e.g., including the illustrative signal 324 shown) to begin various address swap operations. For example, with such one or more signals, DMA controller circuit 300 uses one or more hardware hooks to recognize and change address translations, memory mappings, and/or other information which is used to provide access to a given page in memory.

In the example embodiment shown, signal 324 is provided to invalidation logic 320 of DMA controller circuit 300. In response to signal 324, invalidation logic 320 generates a message 322 to disable a processor core functionality that would otherwise facilitate the performance of a type of transaction based on data which is currently at the over-utilized page. For example, message 322 is sent to a cache and homing agent (or other cache controller circuitry of a processor) which, in response, accesses a translation lookaside buffer to invalidate one or more entries which reference an address associated with the over-utilized page.

Additionally or alternatively, signal 324 is provided to an address manager 330 of DMA controller circuit 300, where—in response—the address manager 330 updates a page table and/or other such mapping information. In an embodiment, such an update associates a virtual address with a physical address of the target page—e.g., as a replacement for a current association of the virtual address with a physical address of the over-utilized page. Additionally or alternatively, signal 324 is provided to a read/write engine 340 of DMA controller circuit 300, where—in response—the read/write engine 340 migrates data from the over-utilized page to the target page. In an embodiment, the migration removes all data from the over-utilized page while processor access to the over-utilized page is disabled—e.g., using read operations and write operations that (for example) are adapted from conventional DMA techniques. Subsequently, a translation lookaside buffer and/or other such reference information is updated to enable access to the target page based on the recently-associated virtual address.

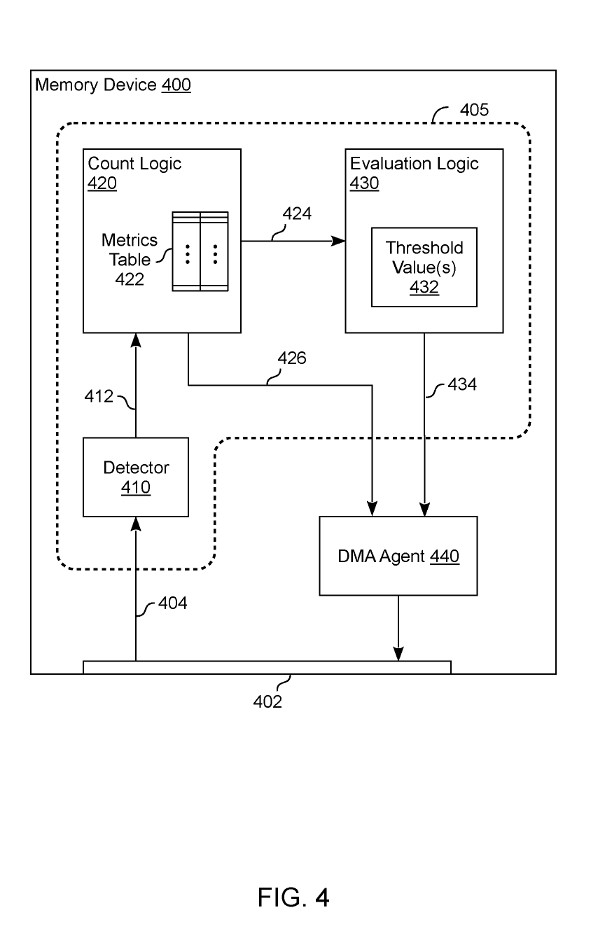

FIG. 4 shows features of memory device 400 to facilitate an address swap for respective pages of two different DIMMs according to an embodiment. In various embodiments, memory device 400 is a DIMM or, for example, one of multiple RAM devices of a DIMM. Memory device 400 includes features of one of DIMMs 160, . . . , 170, for example, and/or is used to perform some or all of method 200.

As shown in FIG. 4, memory device 400 includes interface circuitry 402 by which memory device 400 is to be coupled to a host—e.g., where interface circuitry 402 is to communicate data signals, command signals, clock signals and/or other information (represented by signals 404) with a memory controller such as MC 130. Memory device 400 further comprises a monitor circuit 405 (corresponding functionally to monitor logic 166 or monitor logic 176, for example) which is to determine memory access metric information. For example, monitor circuit 405 comprises circuitry to calculate metric values which are each based on accesses to a respective one or more lines of memory. In some embodiments, monitor circuit 405 further performs an evaluation of memory utilization based on a given access metric value—e.g., wherein the evaluation compares the value to a corresponding threshold value.

In the example embodiment shown, monitor circuit 405 comprises a detector 410 which is coupled to snoop or otherwise detect a memory access which is requested of memory device 400—e.g., where detector 410 identifies one or more characteristics of a memory access message based on signals 404 which, for example, are further communicated to command decoder circuitry, address decoder circuitry and/or other circuit logic of memory device 400 (not shown). For example, detector 410 identifies a given memory access as belonging to one or more memory access types—e.g., including a type corresponding to a particular memory line which is being accessed, a memory read type, a memory write type, and/or the like.

Based on signals 404, detector 410 provides a signal 412 to count logic 420 of monitor circuit 405, the signal 412 indicating an identified access type of a detected memory access. In one example embodiment, count logic 420 maintains, for each of multiple access types, a respective count of memory accesses which are of that type. For example, based on signals 412, counter logic 420 generates, updates or otherwise determines various access metric values (represented by the illustrative metrics table 422) which each indicate a respective level of utilization of a corresponding line, page or other such memory resource. In one embodiment, entries of metrics table 422 each include a respective address or other such identifier of one or more memory lines, and a current count or other metric value based on accesses to said one or more memory lines. Metrics table 422 is updated over time by counter logic 420—e.g., responsive to signals 412 subsequently indicating various additional memory accesses.

Monitor circuit 405 further comprises evaluation logic 430 which is coupled to receive from count logic 420 a signal 424 which identifies a current metric value for a given line. Based on signal 424, evaluation logic 430 determines whether the indicated metric value is indicative of a predetermined criteria for the performance of address swap operations. In an example embodiment, evaluation logic 430 includes or otherwise has access to one or more threshold values 432 which are to be compared to a metric value for a given line, page or other memory resource. In some embodiments, the one or more threshold values 432 include multiple threshold values each corresponding to a different respective one or more lines of memory. In another embodiment, a single threshold value—e.g., a threshold maximum number of write accesses—is used to variously evaluate the utilization of each memory lines of memory device 400.

Memory device 400 further comprises a DMA agent 440 which is coupled to monitor circuit 405—e.g., where DMA agent 440 corresponds functionally to DMA agent 168 (or DMA agent 178). Where it is determined, based on an evaluation of a metric value, that overutilization of a page in memory is indicated, a signal 434 from evaluation logic 430 communicates to DMA agent 440 that an address swap is to be performed. In an embodiment, signal 434 identifies an over-utilized page, from which data is to be migrated to a target page of some other DIMM (which is to be coupled to memory device 400). Based on signal 434, DMA agent 440 participates in communications with a DMA circuitry of a host (such as DMA controller 140) to facilitate address swapping operations such as those described herein.

In some embodiments, DMA agent 440 further facilitates address swapping by providing, to a DMA circuit of the host, information which facilitates the identification of one or more candidate pages for other address swapping. For example, DMA agent 440 is further coupled to receive from count logic 420 a signal 426 which identifies a page which, according to metric values in metric table 422, is relatively less used than some or all other pages represented in metric table 422. Based on signal 426, DMA agent 440 indicates this relatively less utilized (and thus, more preferred) candidate page to host-side DMA logic—e.g., wherein an identifier of the candidate page is subsequently kept in page priority table 312 (or other such reference information).

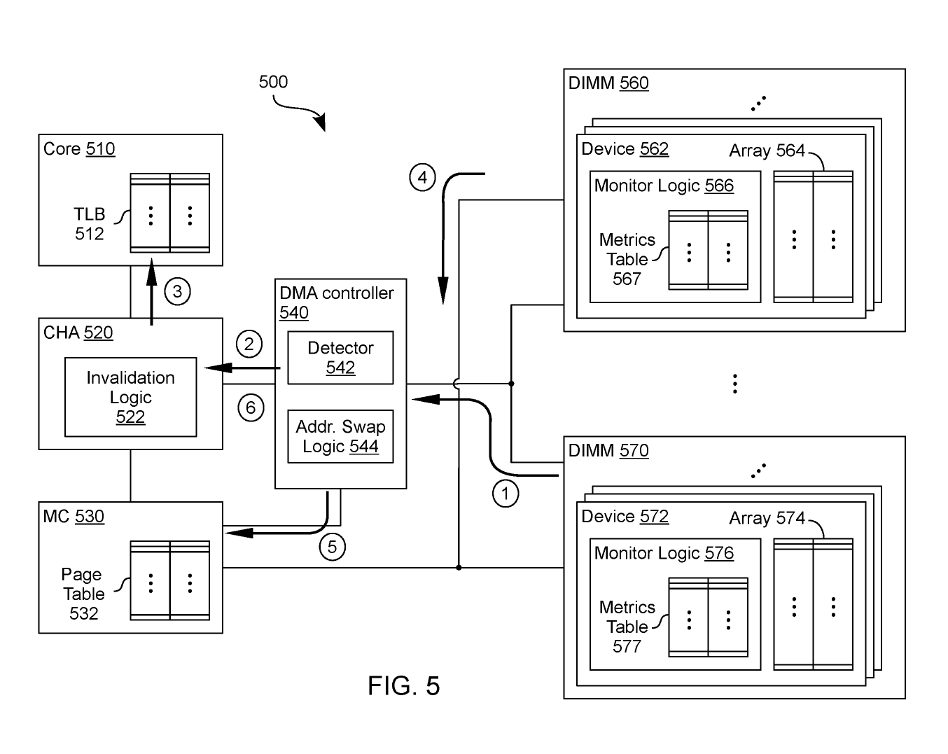

FIG. 5 shows features of a system 500, according to an embodiment, to provide DMA functionality in support of address swapping for segments of different respective DIMMs. System 500 is one example of an embodiment wherein a host processor is coupled to a memory sub-system which comprises multiple DIMMs, wherein a DMA controller facilitates address swap operations in support of data migration between pages of different respective DIMMs. System 500 includes features of system 100 and/or is used to perform some or all of method 200, for example.

As shown in FIG. 5, a processor of system 500 comprises a core 510, a cache and homing agent CHA 520 and an integrated memory controller MC 530, which (for example) provide respective functionality of the one or more cores 122, cache controller 124 and MC 130.

MC 530 provides core 510 with access to DIMMs 560, . . . , 570 (e.g., DIMMs 160, . . . , 170) of the memory sub-system. DIMM 560 comprises packaged RAM devices—e.g. including device 562—which are variously coupled to a printed circuit board of DIMM 560. Similarly, DIMM 570 comprises packaged RAM devices—e.g. including device 572—which are variously coupled to a printed circuit board of DIMM 570. Additionally, a DMA controller 540 (e.g., DMA controller 140) provides access to the memory sub-system independent of such access being requested by a software process which executes with core 510. DMA controller 540 is to variously communicate with respective DMA agents (not shown) of DIMMs 560, . . . , 570—to receive respective metric monitoring information from said DMA agents.

System 500 supports address swapping for pages of different respective DIMMs—e.g., for a first page in a memory array 564 of device 562 and a second page in a memory array 574 of device 572—where address swapping is performed with DMA controller 540. In an example embodiment, operation of system 500 includes core 510 variously accessing some or all of DIMMs 560, . . . , 570, where such accesses are based on a page table 532 which is included in or coupled to MC 530. Page table 532 associates virtual addresses each with a respective physical address of a corresponding memory segment. In one such embodiment, the first page of array 564 and the second page of array 574 correspond to a first physical address and a second physical address (respectively), where—during some accesses of the first page—page table 532 defines or otherwise indicates a correspondence of the first physical address with a particular virtual address.

In the embodiment shown, device 562 comprises monitor logic 566 which calculates one or more metrics each based on respective accesses to device 562, and evaluates the one or more metrics each based on a respective one or more threshold values. Similarly, monitor logic 576 of device 572 calculates one or more metrics each based on respective accesses to device 572, and evaluates the one or more metrics each based on a respective one or more threshold values. An access metric such as one calculated by monitor logic 566 (or by monitor logic 576) indicates an extent to which one or more lines of memory are being subject to wear due to overutilization. In an example embodiment, functionality of monitor circuit 405 is provided with monitor logic 566 (or with monitor logic 576).

DMA controller 540 comprises a detector 542 which is coupled to detect signaling from DIMMs 560, . . . , 570 which indicates, based on an access metric evaluation, whether address swapping is to be performed. In an example scenario according to one embodiment, detector 542 receives a signal (indicated by the communication “1” shown) which indicates excessive utilization of one or more memory lines at the first page of array 564. In response to such detection, address swap logic 544 of DMA controller 540 determines that data at the first page of array 564 is to be migrated from DIMM 560 to the second page at array 574 (for example). For example, address swap logic 544 includes or otherwise has access to circuitry which determines a ranked order of multiple candidate pages, each of a respective DIMM other than DIMM 560. The ranked order is based, for example, on access metrics which each correspond to a respective one of the multiple pages, wherein the second page is selected from among the multiple pages according to the ranked order.

Based on a determination that the second page is to participate in address swapping, address swap logic 544 sends a message (indicated by the communication “2” shown) to invalidation logic 522 of CHA 520—e.g., where invalidation logic 522 is a counterpart to the invalidation logic 320 of DMA circuitry 300. Responsive to address swap logic 544, invalidation logic 522 signals core 510 (as indicated by the communication “3” shown) to invalidate one or more entries of a TLB 512, where such invalidation disables transactions by core 510, if any, which would otherwise access the first page at array 564.

While such transactions by core 510 are disabled, address swap logic 544 performs direct memory access operations to migrate data (indicated by the communication “4” shown) from the first page of array 564 to the second page of array 574. After such migration is completed, address swap logic 544 sends another message to MC 530 (as indicated by the communication “5” shown), the message to update page table 532. In an embodiment, the updating of page table 532 replaces a correspondence of a virtual address to the first physical address with a correspondence of that virtual address to a second physical address for the second page. Address swap logic 544 further sends another message (indicated by the communication “6” shown) for invalidation logic 522 to validate entries of TLB 512—if any—which include or otherwise indicate an address, such as the virtual address, for the second page.

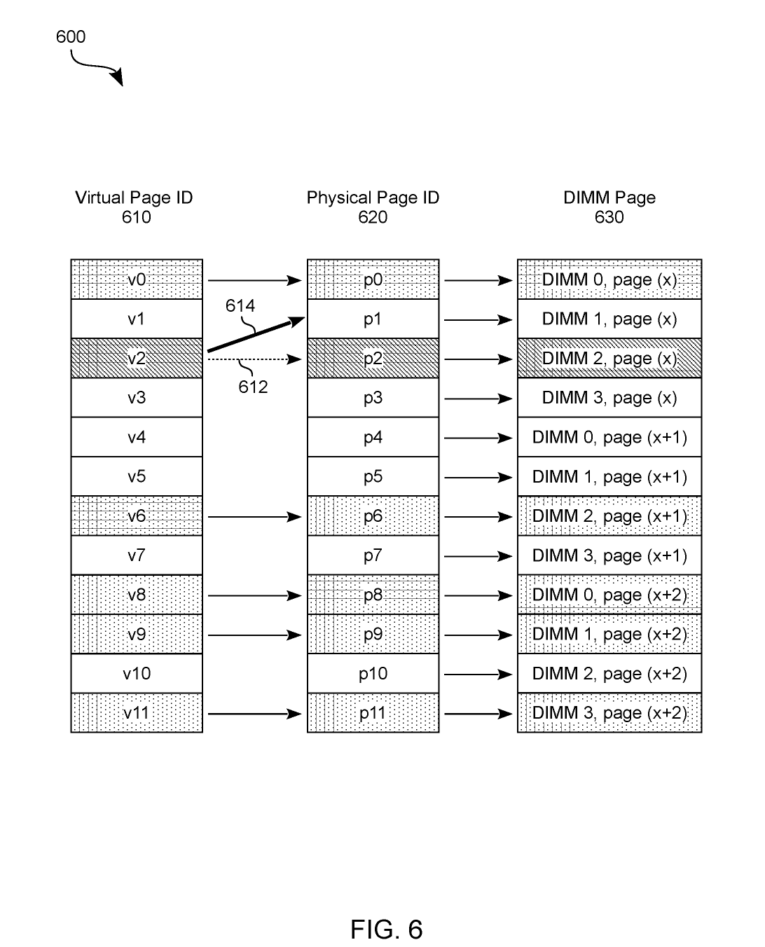

FIG. 6 shows memory addressing 600 to be accessed in support of address swapping with a direct memory access controller according to an embodiment. Addressing information 600 is provided at one of systems 100, 500 and/or is accessed by an operation of method 200, for example. In some embodiments, reference information 132 and/or page table 532 provides some or all of memory addressing 600.

As shown in FIG. 6, memory addressing 600 comprises virtual addresses which are represented as virtual page identifiers 610 (such as the illustrative identifiers v0, . . . , v11 shown), and physical addresses which are represented as physical page identifiers 620 (such as the illustrative identifiers p0, . . . , p11 shown). Column 630 of FIG. 6 identifies pages in physical memory—e.g., each page of a respective DIMM—which are each addressed by a corresponding one of the physical page identifiers 620. More particularly, column 630 shows, for each of DIMMs 1 through 3, respective pages (x) through (x+2).

In an embodiments, a metric of some or all accesses to a given page—in this example, page (x) of DIMM 2—is monitored to detect whether a utilization of one or more lines of that page exceeds a predetermined criteria. During such accesses, virtual addresses are variously associated each with a respective physical address of a corresponding page in memory. In the example embodiment shown, virtual address v0 corresponds to physical address p0 for a page (x) of DIMM 0, while virtual address v2 corresponds to physical address p2 for a page (x) of DIMM 2, and while virtual address v6 corresponds to physical address p6 for a page (x+1) of DIMM 2. Furthermore, virtual address v8 corresponds to physical address p8 for a page (x+2) of DIMM 0, while virtual address v9 corresponds to physical address p9 for a page (x+2) of DIMM 1, and while virtual address v11 corresponds to physical address p11 for a page (x+2) of DIMM 3. Also during such accesses, the utilization (if any) of one or more others of the physical pages 630 is relatively low—e.g., where some or all of physical page identifiers p1, p3 through p5, p7 and p10 are not assigned any of the virtual page identifiers 610.

In such an embodiment, over-utilization of page (x) in DIMM 2 is detected based on an evaluation of the corresponding access metric. In response, another page of a different DIMM—in this example, page (x) of DIMM 1—is selected as a target page to participate in address swapping. The address swapping includes updating the memory addressing 600 to replace a correspondence 612, between virtual page identifier v2 and physical page identifier p2, with a correspondence 614 between virtual page identifier v2 and physical page identifier p1. In an embodiment, the updating takes place after data is migrated—using direct memory accesses—from the page (x) in DIMM 2 to page (x) in DIMM 1.

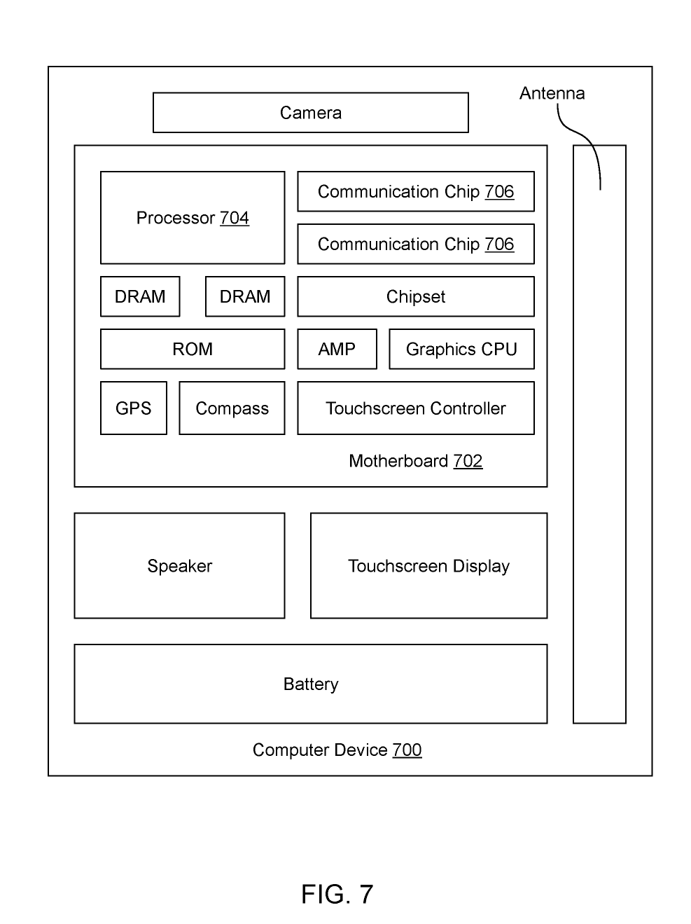

FIG. 7 illustrates a computing device 700 in accordance with one embodiment. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704.

Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others.

The processor 704 of the computing device 700 includes an integrated circuit die packaged within the processor 704. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706.

In various implementations, the computing device 700 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 700 may be any other electronic device that processes data.

Some embodiments may be provided as a computer program product, or software, that may include a machine-readable medium having stored thereon instructions, which may be used to program a computer system (or other electronic devices) to perform a process according to an embodiment. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

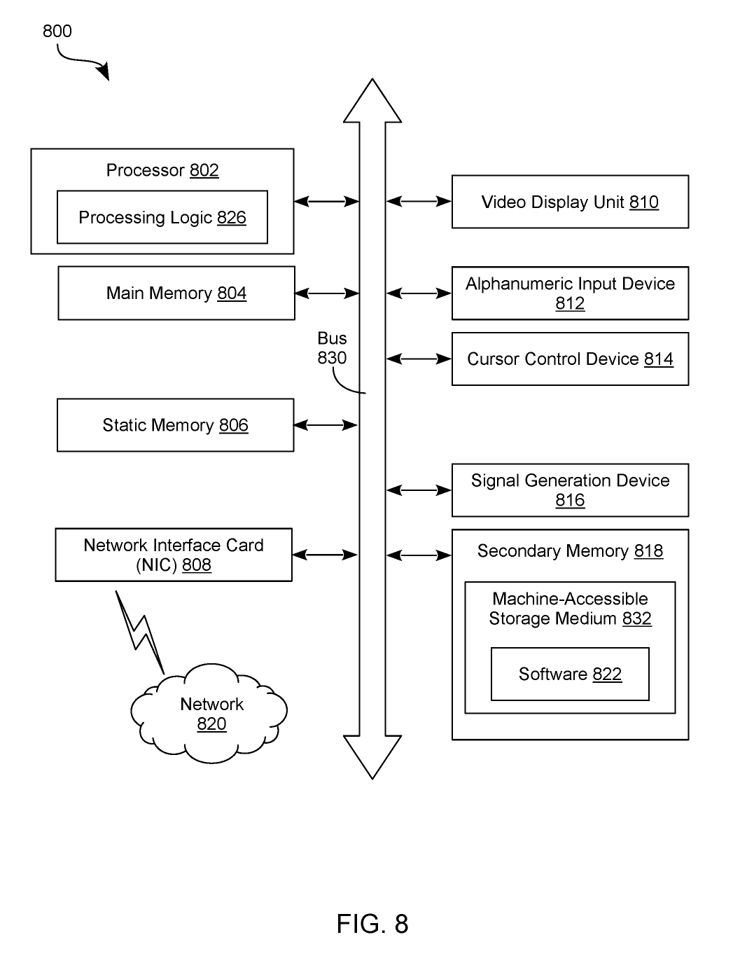

FIG. 8 illustrates a diagrammatic representation of a machine in the exemplary form of a computer system 800 within which a set of instructions, for causing the machine to perform any one or more of the methodologies described herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies described herein.

The exemplary computer system 800 includes a processor 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a secondary memory 818 (e.g., a data storage device), which communicate with each other via a bus 830.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 802 may also be one or more special-purpose processing devices such as an application specific integrated circuit (ASIC), a field programmable gate array (FPGA), a digital signal processor (DSP), network processor, or the like. Processor 802 is configured to execute the processing logic 826 for performing the operations described herein.

The computer system 800 may further include a network interface device 808. The computer system 800 also may include a video display unit 810 (e.g., a liquid crystal display (LCD), a light emitting diode display (LED), or a cathode ray tube (CRT)), an alphanumeric input device 812 (e.g., a keyboard), a cursor control device 814 (e.g., a mouse), and a signal generation device 816 (e.g., a speaker).

The secondary memory 818 may include a machine-accessible storage medium (or more specifically a computer-readable storage medium) 832 on which is stored one or more sets of instructions (e.g., software 822) embodying any one or more of the methodologies or functions described herein. The software 822 may also reside, completely or at least partially, within the main memory 804 and/or within the processor 802 during execution thereof by the computer system 800, the main memory 804 and the processor 802 also constituting machine-readable storage media. The software 822 may further be transmitted or received over a network 820 via the network interface device 808.

While the machine-accessible storage medium 832 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any of one or more embodiments. The term “machine-readable storage medium” shall accordingly be taken to include, but not be limited to, solid-state memories, and optical and magnetic media.

Techniques and architectures for leveling wear among memory devices are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A controller circuit comprising:
first circuitry to couple the controller circuit to a processor core, a first dual inline memory module (DIMM) and a second DIMM;
second circuitry to detect a condition wherein a metric of accesses to a first page of the first DIMM is outside of a range, wherein the accesses are based on information which associates virtual addresses each with a respective physical address, wherein the first page corresponds to a first physical address;
third circuitry, responsive to the second circuitry, to:
disable a functionality of the processor core which supports a class of transactions that access the first page;
perform a direct memory access to migrate data of the first page to a second page of a second DIMM, wherein the second page corresponds to a second physical address; and
update the information to replace a first correspondence of a virtual address to the first physical address with a second correspondence of the virtual address to the second physical address.

2. The controller circuit of claim 1, further comprising:
fourth circuitry to select the second page from among multiple pages each of a respective DIMM other than the first DIMM, wherein, for each page of the multiple pages, a utilization of the page is determined to be less than a utilization of a respective one or more other pages.

3. The controller circuit of claim 2, further comprising:
fifth circuitry to determine a ranked order of the multiple pages relative to each other, wherein the ranked order is based on access metrics each corresponding to a respective one of the multiple pages, wherein the second page is selected from among the multiple pages according to the ranked order.

4. The controller circuit of claim 1, further comprising fourth circuitry to receive from the first DIMM a result of an evaluation which is based on a value of the metric and a threshold value, wherein the second circuitry detects the condition based on the result.

5. The controller circuit of claim 4, wherein, for each of multiple random access memory (RAM) devices of the first DIMM, the fourth circuitry is further to receive from the RAM device a respective result of an evaluation, by the RAM device, of a corresponding metric of accesses to the RAM device.

6. The controller circuit of claim 1, wherein the processor core comprises a translation lookaside buffer, and wherein the third circuitry to disable the functionality comprises the third circuitry to signal a cache controller of the processor to invalidate an entry of the translation lookaside buffer.

7. The controller circuit of claim 1, wherein a page table comprises the information.

8. The controller circuit of claim 1, wherein, of all memory lines of the first page, the metric of accesses is based on accesses to only a first memory line.

9. A memory device comprising:
first circuitry to couple the memory device to a host while a first dual inline memory module (DIMM) comprises the memory device, and while the host is further coupled to a second DIMM, wherein the host is to comprise a processor and a controller circuit;
second circuitry to communicate to the controller circuit a signal indicating a condition wherein a metric of accesses to a first page of the first DIMM is outside of a range, wherein the accesses are based on information which associates virtual addresses each with a respective physical address, wherein the first page corresponds to a first physical address, wherein responsive to the signal, the controller circuit is to:
disable a functionality of the processor core which supports a class of transactions that access the first page; and
perform a direct memory access to migrate data of the first page to a second page of the second DIMM, the second page corresponding to a second physical address; and
update the information to replace a first correspondence of a virtual address to the first physical address with a second correspondence of the virtual address to the second physical address.

10. The memory device of claim 9, further comprising:
third circuitry to calculate a value of the metric;
fourth circuitry to perform an evaluation based on the value of the metric and a corresponding threshold value, wherein the signal indicates a result of the evaluation.

11. The memory device of claim 10, wherein the first DIMM is the memory device.

12. The memory device of claim 10, wherein the first DIMM comprises multiple RAM devices, wherein the memory device is a first RAM device of the multiple RAM devices.

13. The memory device of claim 9, wherein, of all memory lines of the first page, the metric of accesses is based on accesses to only a first memory line.

14. The memory device of claim 9, further comprising:
third circuitry to determine access metrics each corresponding to a different respective page of multiple pages of the memory device;
fourth circuitry to determine, based on the access metrics, a ranked order the multiple pages relative to each other;
fifth circuitry to select a third page from among the multiple pages based on the ranked order; and
sixth circuitry to communicate another signal to identify the third page to the controller circuit, wherein data is migrated from the third page based on the other signal.

15. A system comprising:
a memory sub-system comprising a first dual inline memory module (DIMM) and a second DIMM;
a processor comprising a core;
a controller circuit coupled to each of the processor, the first DIMM and the second DIMM, the controller circuit comprising:
first circuitry to detect a condition wherein a metric of accesses to a first page of the first DIMM is outside of a range, wherein the accesses are based on information which associates virtual addresses each with a respective physical address, wherein the first page corresponds to a first physical address;
second circuitry, responsive to the first circuitry, to:
perform a direct memory access to migrate data of the first page to a second page of the second DIMM; and
update the information to replace a first correspondence of a virtual address to the first physical address with a second correspondence of the virtual address to a second physical address which corresponds to the second page; and
a display device coupled to the processor, the display device to display an image based on the data.

16. The system of claim 15, the second circuitry further to disable a functionality of the core based on the condition, wherein the functionality supports a class of transactions that access the first page, and wherein the second circuitry is to both perform the direct memory access and update the information while the functionality is disabled.

17. The system of claim 15, the controller circuit further comprising:
third circuitry to select the second page from among multiple pages each of a respective DIMM other than the first DIMM, wherein, for each page of the multiple pages, a utilization of the page is determined to be less than a utilization of a respective one or more other pages.

18. The system of claim 17, the controller circuit further comprising:
fourth circuitry to determine a ranked order of the multiple pages relative to each other, wherein the ranked order is based on access metrics each corresponding to a respective one of the multiple pages, wherein the second page is selected from among the multiple pages according to the ranked order.

19. The system of claim 15, the controller circuit further comprising third circuitry to receive from the first DIMM a result of an evaluation which is based on a value of the metric and a threshold value, wherein the first circuitry detects the condition based on the result.

20. The system of claim 19, wherein, for each of multiple random access memory (RAM) devices of the first DIMM, the third circuitry is further to receive from the RAM device a respective result of an evaluation, by the RAM device, of a corresponding metric of accesses to the RAM device.

21. The system of claim 15, wherein the processor further comprises a cache controller, and wherein the processor core comprises a translation lookaside buffer, wherein the second circuitry to disable the functionality comprises the second circuitry to signal the cache controller to invalidate an entry of the translation lookaside buffer.

22. The system of claim 15, wherein, of all memory lines of the first page, the metric of accesses is based on accesses to only a first memory line.
